(19) United States
(12) Patent Application Publication
(10) Pub. No.: US 2002/0021474 A1
(43) Pub. Date: Feb. 21, 2002

(54) Method and apparatus for modulating optical signals based on a dark resonance

(76) Inventor: Byoung-Seung Ham, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/899,650

(22) Filed: Jul. 5, 2001

(30) Foreign Application Priority Data
Jul. 6, 2000 (KR) 2000-38721

(51) Int. Cl. G02F 1/00; G02F 2/00; H01S 3/00; H04B 10/00; H04J 14/00; H04B 10/04

(52) U.S. Cl. 359/181; 359/109

(57) ABSTRACT

A method and an apparatus for optical modulators based on dark resonance in which three laser lights interact with at least a three-level nonlinear optical medium composing two closely spaced ground states and an excited state through nondegenerate four-wave mixing. The modulation mechanism is based on the dark resonance induced two-photon coherence between the two closely spaced ground states through optical transitions via an excited state. The two-photon coherence induced on the ground states is optically detected via nondegenerate four-wave mixing. The nondegenerate four-wave mixing generation is enhanced owing to the dark resonance or electomagnetically induced transparency. The modulation time based on the present optical modulation method is not limited by population relaxation time or carrier's lifetime. More advantage is given by signal amplification and line narrowing owing to the dark resonance enhanced nondegenerate four-wave mixing.

### FIELD OF THE INVENTION

The present invention relates to quantum modulator; and more particularly, to an optical modulator for modulating optical signals based on a dark resonance induced two-photon coherence or an electromagnetically induced transparency and a method for implementing the apparatus.

### DESCRIPTION OF THE PRIOR ART

An external optical modulators in optical fiber communication has been developed to increase modulation bandwidth in which the bandwidth of direct optical modulators are critically limited by chirping arisen from the gain-induced variations of the refractive index. Generally the bandwidth limit of the direct optical modulators is ˜10 GHz. Among the external optical modulators are electro-optic, electro-absorption, traveling-wave, and Mach-Zehnder type modulators using semiconductors, LiNbO₃ and polymers. These optical modulation techniques, however, have limitations of the bandwidth in ˜100 GHZ due to an RC time constant for the electro-absorption and velocity mismatch for the traveling-wave. Those optical modulation techniques are based on direct electric current control.

On the other hand, there is an all-optical modulation technique based on a dark resonance or an electromagnetically induced transparency (EIT) in the context of optically thick medium. In EIT, a resonant optical field can pass through an optically thick medium without experiencing absorption. The basic physics of the transparency at line center is in the existence of dark state, which is a decoupled superposition state from the excited state. The required energy level structure for dark resonance is two closely spaced ground states and an excited state for a type, or two closely spaced excited states and a ground state for a V-Type, or arbitrarily spaced three states for a ladder type. When two-color electromagnetic fields interact with a three-level system, refractive index changes occur to the medium owing to the dark resonance. The refractive index change is induced to either the direct optical transition of the medium or to the two closely spaced states via the third state. The refractive index change by two-color electromagnetic fields in a three-level optical medium results in absorption cancellation to the applied fields at absorption line center. At the same time, strong two-photon coherence is induced on the closely spaced states.

The refractive index changes caused by the two-color electromagnetic fields interacting with a three-level optical medium can, therefore, be controlled by one of the applied optical fields. The use of direct refractive index change based on EIT was proposed for a frequency conversion (Schmidt et al., in Applied Physics Letters, Vol. 76, pp. 3173-3176 (2000). An application of optical switch using the direct optical absorption cancellation due to the dark resonance is also suggested in a three fields interacting four-level system (Harris et al., Physical Review Letters, Vol.81, pp. 3611-3613 (1998)). Another application of optical switch using two-photon coherence swapping due to the dark resonance exchange is demonstrated in a three fields interacting four-level system (Ham et al., Physical Review Letters, Vol. 84, pp. 4080-4083 (2000)).

In a dark resonance the time needed for refractive index change is not limited by the carriers' lifetime or population relaxation time. The two-photon coherence induction on the two closely spaced ground states can be optically detected by nondegenerate four-wave mixing. The optical intensity of the nondegenerate four-wave mixing signal can be stronger than the original input laser lights. This signal amplification in the nondegenerate four-wave mixing based on a dark resonance was already demonstrated experimentally in atomic vapors and ion-doped solids.

### SUMMARY OF THE INVENTION

It is, therefore, a primary object of the present invention to provide a method of an optical modulator based on a dark resonance or EIT, wherein this optical modulator based on the dark resonance is named quantum modulator, the main characteristics of the quantum modulator are that the switching mechanism is based on the two-photon coherence induced by two color laser lights interacting with a three-level type (or four-level double type) nonlinear optical medium and the modulation bandwidth of the present invention is not limited by the population relaxation time or carrier's lifetime.

It is another object of the present invention to provide a method and apparatus of the quantum modulator for all-optical, ultrawide bandwidth, signal amplifiable, and line narrowed modulation devices.

In accordance with one aspect of the present invention, there is provided a method for quantum modulating optical signals by using a nonlinear optical medium, wherein the nonlinear optical medium includes two closely spaced ground states |1> and |2> such that the transition among the ground states is dipole forbidden, and an excited state |3> such that two-photon transition between the ground states |1> and |2> via the excited state |3> is allowed, the method comprising the steps of: a) applying a first continuous wave (cw) laser light as an input to the nonlinear optical medium through an optical fiber or free space at a frequency of ω_{α} corresponding to a first transition between the ground state |1> and the excited state |3>; b) applying a second laser light to the nonlinear optical medium through an optical fiber or free space at a frequency of ω_{β} corresponding to a second transition between the ground state |2> and the excited state |3>; c) adjusting the intensities of the first laser light ω_{α} and the second laser beam ω_{β} to produce a strongly driven superposition state composed of the ground state |1> and the |2> creating two-photon coherence induction Reρ₁₂; d) applying a third laser light to the nonlinear optical medium through an optical fiber or free space at a frequency of ωₚ corresponding to a third transition between the ground state |2> and the excited state |3> for nondegenerate four-wave mixing or phase conjugation geometry with the first laser light ω_{α}, the second laser light ω_{β}, and the third laser light ωₚ to produce nondegenerate four-wave mixing signal ω_{d}; and e) connecting the nondegenerate four-wave mixing signals ω_{d} to do an optical fiber.

In accordance with another aspect of the present invention, there is provided a method for quantum modulating optical signals by using a nonlinear optical medium, wherein the nonlinear medium includes two closely spaced ground states |1l> and |2> such that the transition between the ground states is dipole forbidden, and two closely spaced excited states |3> and |4> such that the transition between the excited states is dipole forbidden, and such that two-photon transition between the ground state |1> and the |2> via the excited state |3> or |4> is allowed, the method comprising the steps of: f) applying a first continuous wave (cw) laser light as an input to the nonlinear optical medium through an optical fiber or free space at a frequency of ω_{α} corresponding to a first transition between the ground state |1> and the excited state |3>; g) applying a second laser light to the nonlinear optical medium through an optical fiber or free space at a frequency of ω_{β} corresponding to a second transition between the ground state |2> and the excited state |3>; h) adjusting the intensities of the first laser light ω_{α} and the second laser beam ω_{β} to produce a strongly driven superposition state composed of the ground state |1> and the |2> creating two-photon coherence induction Reρ₁₂; i) applying a third laser light to the nonlinear optical medium through an optical fiber or free space at a frequency of ωₚ corresponding to a third transition between the ground state |2> and the excited state |4> for nondegenerate four-wave mixing or phase conjugation geometry with the first laser light ω_{α}, the second laser light ω_{β}, and the third laser light ωₚ to produce nondegenerate four-wave mixing signal ω_{d}; and j) connecting the nondegenerate four-wave mixing signals ω_{d} to an optical fiber.

### BRIEF DESCRIPTION OF THE DRAWINGS

The above and other objects and features of the present invention will become apparent from the following description of the preferred embodiments given in conjunction with the accompanying drawings, in which:

FIG. 1 illustrates a schematic diagram of the present invention;

FIG. 2 shows an energy level diagram of the nonlinear optical medium of FIG. 1, where the frequency difference between the ground states is much smaller comparing with the transition frequency between the ground and the excited states;

FIG. 3 illustrates a refractive index change caused by a dark resonance;

FIG. 4 illustrates two-photon coherence induction on the ground states |1> and |2> by laser lights ω₁ and ω₂ of the inset in FIG. 3 for modulation bandwidth of 1 THz;

FIG. 5 illustrates two-photon coherence induction on the ground states |1> and |2> by laser lights ω₁ and ω₂ of the inset in FIG. 3 for modulation bandwidth of 10 THz;

FIG. 6 illustrates manipulation of the two-photon coherence induction on the ground states |1> and |2> by the control of phase decay rate between two closely spaced ground states for equal magnitude of the two-photon coherence strength;

FIG. 7 illustrates the dark resonance induced coherence excitation as a function of interaction time of the laser light ω₂ of the inset in FIG. 3;

FIG. 8A illustrates a schematic diagram of the laser interaction with the nonlinear optical medium of FIG. 1 for an all-optical quantum modulator in a forward propagation scheme; and

FIG. 8B illustrates a schematic diagram of the laser interaction with the nonlinear optical medium of FIG. 1 for an all-optical quantum modulator in a backward propagation scheme.

### DETAILED DESCRIPTION OF THE PREFERRED EMBODIMENTS

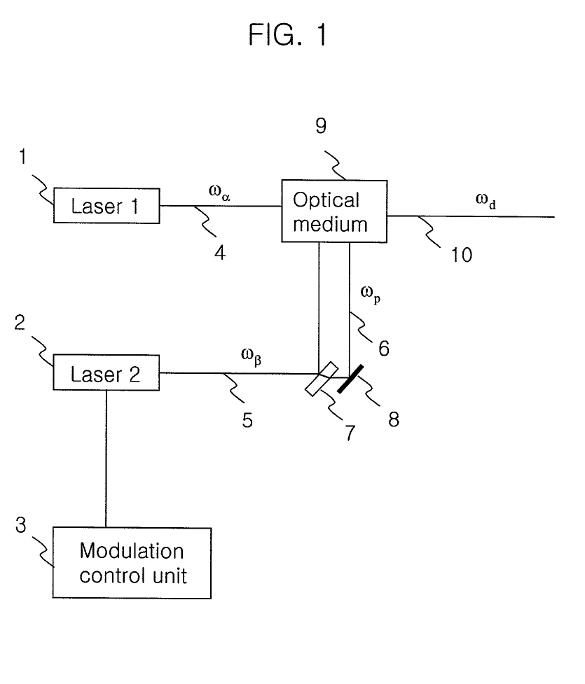

To gain a better understanding reference is now made to the drawings, which illustrate the preferred embodiments of the invention. Referring to FIG. 1, the system of the present invention is shown. The main component of the system is composed of four laser inputs 4 through 6, nonlinear optical medium 9, and a light outputs 10. The laser inputs are focused to the nonlinear optical medium 9 by a lens (not shown) . The laser 1 is a light source in continuous wave (cw), and the laser 2 is a control light, which is operated by the modulation control unit 3. The laser input 6 is split from the laser 5 by a fiber coupler (not shown) for a fiber transmission scheme or by a beam splitter 7 for a free space transmission scheme. The laser input frequencies of 5 and 6 are ω_{β} and ωₚ. respectively. The laser input frequencies of 4 is ω_{α}.

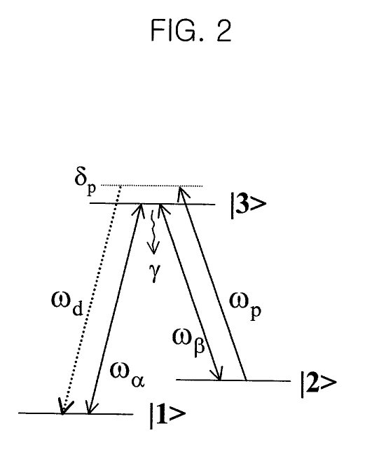

The energy level diagram of the nonlinear optical medium 9 of FIG. 1 is shown in FIG. 2. Here, the lower two closely spaced energy levels can be selectively chosen from the hyperfine states of most atomic vapors or most rare-earth doped crystals. The energy level structures of FIG. 2 can also be made artificially by doubly coupling semiconductor quantum wells. The minimum number of energy states of the nonlinear optical medium 9 of FIG. 1 is at least 3; |1>, |2> and |3>. The state |3> of FIG. 2 is one of the excited states, which are higher than |1> and |2>, and |2> is higher than |1> in energy. The δₚ of FIG. 2 is a detuning of ωₚ from the resonance frequency of |2> to |3> transition, i.e., δₚ=ω₃₂−ωₚ, where ω₃₂=ω₃−ω₂. The value of ωₚ depends on the following conditions. Option 1: If the frequencies of ωₚ and ω₆₂ are the same each other, then the laser pulses 5 and 6 of FIG. 1 should not be overlapped temporally to avoid the degenerate four-wave mixing effect caused by the ωₚ and ω_{β}. The laser input 6 of FIG. 1 should be always followed by the laser input 5 of FIG. 1 within the range of phase relaxation time T₁₂ between the energy levels |1> and |2> of FIG. 2. This time delay can be easily made by adjusting the light path difference between the optics 7 and 8 of FIG. 1. Option 2: If the frequencies of ωₚ and ω₂ are different, then the temporal overlap of ω₂ and ωₚ should give better effect for the nondegenerate four-wave mixing. In the option 2, the ωₚ may tune to another energy level separated by δₚ from the level |3> for a double type four-level system (Ham et al., Optics letters, Vol. 24, pp. 86-88 (1999)), which is incorporated herein by reference. The laser output ω_{d} (10 of FIG. 1) is generated by nondegenerate four-wave mixing propagating involving three laser interactions of ω_{α}, ω_{β} and ωₚ in FIG. 2 with the nonlinear optical medium 9 of FIG. 1. The propagation directions k_{d} of the nondegenerate four-wave mixing signal ω_{d} of FIG. 2 are determined by the phase matching condition k_{1d}=k_{α}−k_{β}+kₚ. Here, the nondegenerate four-wave mixing generation is strongly enhanced owing to a dark resonance or EIT. To understand the enhancement of the nondegenerate four-wave mixing more detail explanation is presented below.

Enhancement of nondegenerate four-wave mixing was suggested by Harris in Physical Review Letters, Vol. 64, pp. 1107-1110 (1991) and were demonstrated experimentally in atomic gases by Jain et al. in Optics Letters Vol. 18, pp. 98-101 (1993) and in ion-doped solid by Ham et al. in Optics Letters, Vol. 22, pp. 1138-1140 (1997), which are incorporated herein by references. Signal amplifications and high-conversion efficiency using atomic gases in the nondegenerate four-wave mixing were experimentally demonstrated by Hemmer et al. in Optics Letters, Vol. 20, pp. 982-984 (1995) and Jain et al. in Physical Review Letters, Vol. 77, pp. 4326-4329 (1996), which are incorporated herein by references, respectively. The high-conversion efficiency of the nondegenerate four-wave mixing was also experimentally demonstrated in ion-doped solids by Ham et al. in Physical Review A, Vol. 59, pp. R2583-2586 (1999), which are incorporated herein by reference. The enhancement of nondegenerate four-wave mixing is based on reduced first-order linear susceptibility and increased third-order nonlinear susceptibility owing to destructive and constructive quantum interference, respectively.

To show more detail relations between the laser inputs and nondegenerate four-wave mixing signals, coherence change should be examined. Density matrix ρ is a useful tool to see system's macroscopic ensemble; Quantum optics, Cambridge University Press, New York, N.Y. (1997) Ed. Scully and Zubairy, which are incorporated herein by references. Therefore, density matrix rate equations are used for more detail calculations of the two-photon coherence induction on the ground states for consecutive laser control pulses in following figures. The density nmatrix ρ is defined by ((M. O. Scully and M. S. Zubairy, Quantum Optics, Cambridge University Press (1997) New York, N.Y., USA), which are incorporated herein by references:

ρ=|Ψ><Ψ| (1)

$$\vert Ψ ⟩ = {\sum }_{i} {a}_{i} ( t ) exp ( 1 - i {ϵ}_{i} t / ℏ ) \vert {u}_{i} > \qquad ( 2 )$$

The Hamiltonian H is

H=h/2π{−δ₁|1><1|−|2><2|−|3><3|−½(Ω₁|1><3|+Ω₂|2><3|)+H.c.}, (3)

where, δ₁=ω_{α}−ω₂₁, Ωᵢ(=1,2) is Rabi frequency of electric field Eᵢ(r,t), and [symbol] is Planck constant h/2π:

Eᵢ(r,t)=½εᵢ(t) exp {i(ωᵢt−k·r)}+c.c., (4-1)

Ωᵢ=πμεᵢ(t)/h. (4-2)

The density matrix rate equations are getting from Shröddinger equation:

$$\vert Ψ ⟩ = - \frac{i}{ℏ} H \vert Ψ ⟩ \qquad ( 5 )$$

The time derivative of the density matrix results in Liouville equation:

$$ρ = - \frac{1}{ℏ} [ H , ρ ] + \text{(decay terms).} \qquad ( 6 )$$

So, from the above equations, time-dependent density matrix equation is:

$${\ddot{ρ}}_{ij} = - \frac{1}{ℏ} {\sum }_{k} ( {H}_{ik} {ρ}_{kj} - {ρ}_{ik} {H}_{kj} ) - \frac{1}{2} ( {γ}_{ik} {ρ}_{kj} + {ρ}_{ik} {γ}_{kj} ) \qquad ( 7 )$$

From the relation (7) total 9 rate equations are derived as follows:

$$\begin{matrix}{\ddot{ρ}}_{11} = - i \frac{{Ω}_{α}}{2} ( {ρ}_{13} - {ρ}_{31} ) + {Γ}_{31} {ρ}_{33} - {Γ}_{12} ( {ρ}_{11} - {ρ}_{22} ) , & ( 8 ) \\ {\ddot{ρ}}_{22} = - i \frac{{Ω}_{β}}{2} ( {ρ}_{23} - {ρ}_{32} ) + {Γ}_{32} {ρ}_{33} - {Γ}_{12} ( {ρ}_{11} - {ρ}_{22} ) , & ( 9 ) \\ {\ddot{ρ}}_{33} = - i \frac{{Ω}_{α}}{2} ( {ρ}_{31} - {ρ}_{13} ) - i \frac{{Ω}_{β}}{2} ( {ρ}_{32} - {ρ}_{23} ) - ( {Γ}_{31} + {Γ}_{32} ) {ρ}_{33} , & ( 10 ) \\ {\ddot{ρ}}_{12} = - i \frac{{Ω}_{β}}{2} {ρ}_{13} + i \frac{{Ω}_{β}}{2} {ρ}_{32} - i ( {δ}_{1} - {δ}_{2} ) {ρ}_{12} - {γ}_{12} {ρ}_{12} , & ( 11 ) \\ {\ddot{ρ}}_{13} = - i \frac{{Ω}_{α}}{2} ( {ρ}_{11} - {ρ}_{33} ) - i \frac{{Ω}_{β}}{2} {ρ}_{12} - i {δ}_{1} {ρ}_{13} - {γ}_{13} {ρ}_{13} , & ( 12 ) \\ {\ddot{ρ}}_{ij} = {\ddot{ρ}}_{μ} ; {\ddot{ρ}}_{ij} = {\ddot{ρ}}_{ji}^{*} , & ( 13 )\end{matrix}$$

where δ₁=ω_{α}−ω₋(ω₃₁=ω₃−ω₁), δ₂=ω_{β}−ω₃₂ (ω₃₂ =ω₃−ω₂), and ρ*ⱼᵢ is a

complex conjugate of ρᵢⱼ. Here, Ψ_{α} and Ψ_{β} are Rabi frequencies of the ω_{α} and ω_{β}, respectively.

In FIG. 2, two laser inputs ω_{α} and ω_{β} induce two-photon coherence ρ₁₂ on the ground state |1>−|2> via the excited state |3>. Especially, the two-photon coherence ρ₁₂ is strongly increased when the dark resonance or EIT involves. Here, the dark resonance or EIT is the same physical phenonmenon, but the term EIT roots in the absorption cancellation when a resonant electromagnetic fields pass through an optically thick medium, so that the resonant light can pass through without experiencing any absorption.

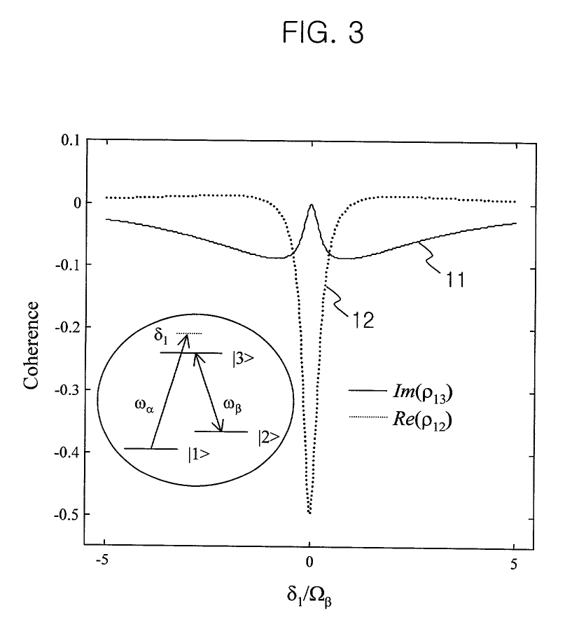

Referring to FIG. 3, refractive index changes induced by the dark resonance in a three-level system interacting with two lasers Ω_{α} and Ω_{β} of FIG. 2 are calculated by solving the density matrix equations assuming a closed system: ρ₁₁+ρ₂₂+ρ₃₃=1. As seen in FIG. 3, the two-photon coherence 12 of Reρ₁₂ is strongly dependent on the one-photon absorption change 11 of Imρ₁₃ at line center. At line center of the laser input 4 of FIG. 1 (ω_{α} of FIG. 2), the two-photon coherence strength 12 of FIG. 3 is strongly enhanced, whereas the one-photon coherence 11 of FIG. 3 is substantially reduced. These are the results of the dark resonance or EIT. The two-photon coherence 12 of FIG. 3 induced on the ground states |1> and |2> (see the inset of FIG. 3) is optically detected via nondegenerate four-wave mixing as mentioned above. The relationship between the enhanced nondegenerate four-wave mixing signal I(ω_{d}) and the two-photon coherence Reρ₁₂ is as follows: I(ω_{d})∝[Reρ₁₂]². This relation was experimentally demonstrated by Ham et al. in Physical Review A, Vol. 59, R2583-R2586 (1999), which is incorporated herein by reference. It should be noted that the spectral width of reduced absorption of 11 or two-photon coherence 12 of FIG. 3 is much narrower than the spontaneous decay rate Γ;Γ₃₁=Γ₃₂=10 THz and Ω_{α}=Ω_{β}=6 THz. This line narrowing in the dark resonance is also experimentally demonstrated theoretically by Lukin et al. in Physical Review Letters, Vol. 79, pp. 2959-2662 (1997) and experimentally by Ham et al. in Optics Letters, Vol. 24, pp. 86-88 (1999), which are incorporated herein by references.

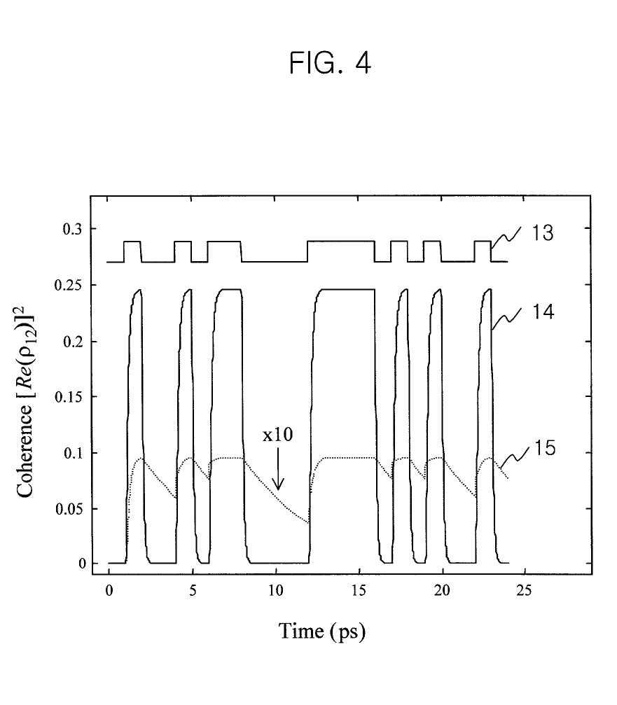

Referring to FIG. 4, two-photon coherence Reρ₁₂ is solved by using the above density matrix rate equations (8) for 1 ps input laser pulses of ω_{β} of the inset in FIG. 3; the Ω_{α} is assumed cw. When the control laser ω_{β} with modulation 13 of FIG. 4 interacts with ω_{α} in the three-level nonlinear optical medium 9 of FIG. 1, the two-photon coherence strength [Reρ₁₂]² 14 also follows up the control modulation with a strong extinction ratio. For the calculations the shape of the control pulse ω_{β} is set to be a square, and the system is closed to be ρ₁₁+ρ₂₂+ρ₃₃=1. Two lasers ω_{α} and ω_{β} are resonant to their optical transitions with the same Rabi frequency Ω, where Ω=Ω_{α}=Ω_{β}=6 THz. Normal semiconductor optical constants are used for the parameters in the calculations; phase relaxation rate γ₃₁=γ₃₂=10 THZ and γ₂₁=0.01 THz, and optical population relaxation rate Γ₃₁=Γ₃₂=5 THz and Γ₂₁=0.01 THz. The control laser modulation 13 stands for ASCII letters “KOR” in the format of non-return to zero binary code. The Rabi frequency ratio Ω_{α}/Ω_{β} is 1 and 0.1 for 14 and 15, respectively. Comparing two-photon coherences 14 and 15 with the control input 13, keeping balanced Rabi ratio is important to produce not only stronger two-photon coherence strength but also wider modulation bandwidth. Here, it should be noted that the value of the two-photon coherence strength 14 is near 0.25, which is the maximum value. From the demonstration of FIG. 4, it is concluded that the cw input laser ω_{α} a can be modulated to a pulsed output ω_{d} having the same modulation 13 as the control laser ω_{β} under the dark resonance conditions.

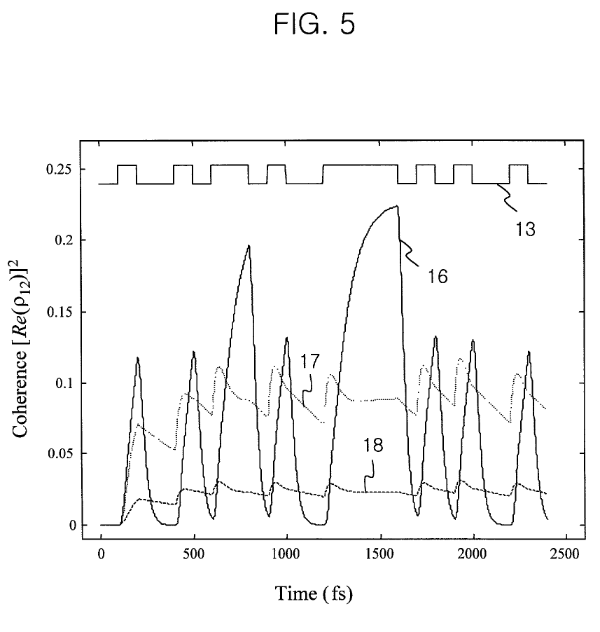

Referring to FIG. 5, ultra wide bandwidth of the quantum modulation is presented. All the parameters and the modulation of the control laser 13 (ω_{β} in FIG. 2) are same as FIG. 4, except pulse length of 13 shortened to 0.1 ps, so that the modulation bandwidth is 10 THz. As seen in FIG. 5, the interactions of input cw laser ω_{α} and pulsed laser ω_{β} with the three-level system 9 of FIG. 1 produce two-photon coherence strength 16 of FIG. 5 with high extinction ratio when the Rabi ratio Ω_{α}/Ω_{β} is unity. The extinction ratio of the two-photon coherence, however, gets weaker as the Rabi ratio becomes smaller. The two-photon coherence strength 17 is for the Rabi ratio of 0.1, and the 18 is for 0.01. The values of the two-photon coherence strengths 17 and 18 are multiplied by a factor of 10 and 1000, respectively.

The unequal strength of the two-photon coherence strength 16 of FIG. 5 gives practical disadvantages for the use of the output signal 10 of FIG. 1. The output 10 of FIG. 1 is generated from the nondegenerate four-wave mixing and the signal generation is proportional to the two-photon coherence strength [Reρ₁₂]² as mentioned above. Therefore, fluctuation of the two-photon coherence strength 16 of FIG. 5 definitely produces unbalanced signal output 10 of FIG. 1 in power. This two-photon coherence fluctuation, however, can be subsidized by adjusting the ground state phase relaxation rate γ₁₂. In semiconductor quantum wells, the value of γ₂₁ can be easily manipulated by adjusting growth conditions. In rare-earth doped solids the value of γ₂₁ can be increased by applying magnetic field gradient.

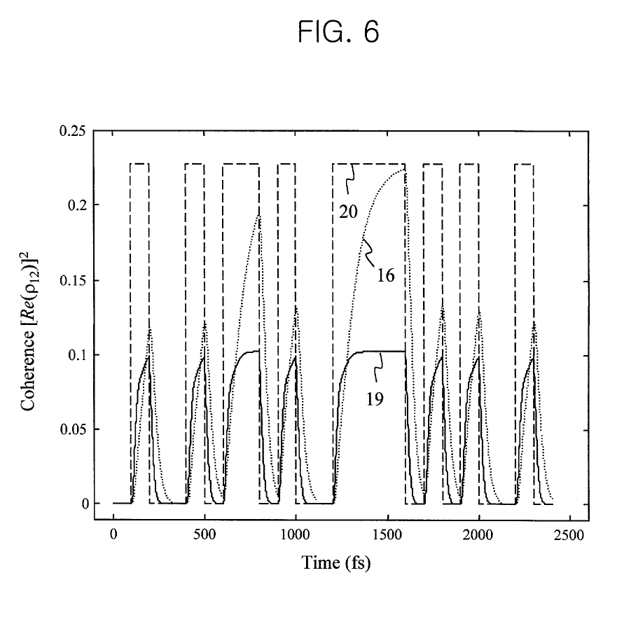

Referring to FIG. 6, the two-photon coherence Reρ₁₂ induced on the ground states |1> and |2> by two lasers ω_{α} and ω_{β} via an excited state |3> in the inset of FIG. 3 is manipulated by adjusting the ground state relaxation rate γ₂₁ to produce equal amplitude of the two-photon coherence Reρ₁₂. The two-photon coherence strength 16 of FIG. 6 is for γ₂₁=0.01γ₃₁ with ×5 in multiplication. On the other hand the curve 19 is for the two-photon coherence strength [Reρ₁₂]² when the ground state phase relaxation rate γ₂₁ is increased up to 0.2 γ₃₁. Therefore, FIG. 6 demonstrates that the increment of the ground state phase relaxation rate γ₂₁ quickens the saturation time of the two-photon coherence Reρ₁₂, producing the equal amplitude of the Reρ₁₂. However, the increment of γ₂₁ weakens the magnitude of the Reρ₁₂ as seen in FIG. 6. Owing to the fast excitation of the two-photon coherence ρ₁₂, quick saturation of the two-photon coherence strength is expected. The curve 20 of FIG. 6 shows two-photon coherence strength for 100-ns pulse width of the control ω_{β} in the inset of FIG. 3. Therefore, FIG. 6 demonstrates 10-THz modulation with constant strength. The modulation bandwidth of the two-photon coherence in FIGS. 5 and 6 is wider than the optical population relaxation rate Γ(5 THz). This demonstrates that repetition rate or bandwidth of the dark resonance based quantum modulation of the present invention is not limited by the carrier's life time or population relaxation rate, which is a critical limitation of the current optical switching technologies (Nakamura et al., IEEE Photon. Technol. Lett. Vol. 10, pp. 1575-1577 (1998), which is incorporated herein by reference).

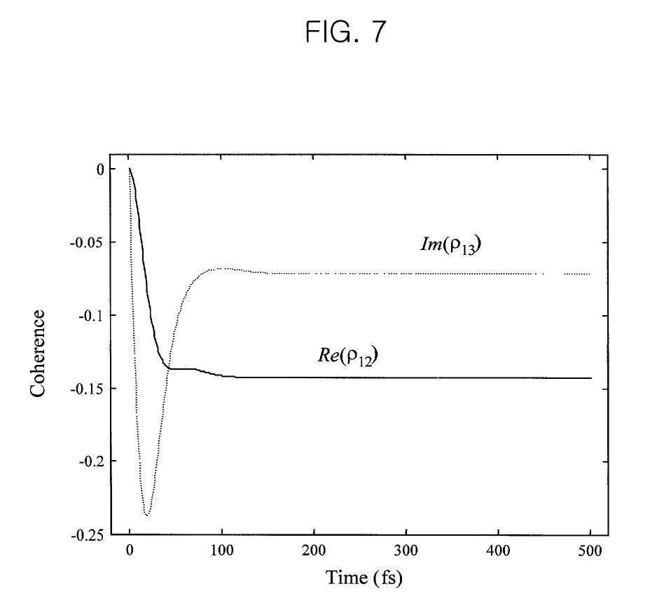

Referring to FIG. 7, more detail calculations of the dark resonance induced coherence excitation is present. In a three-level system composing two closely spaced ground states and an excited state, laser interactions induce two-photon coherence ρ₁₂ on the ground states. For potential application of wide bandwidth optical modulators, fast coherence excitation is much concerned. FIG. 7 illustrates the excitation of the two-photon coherence Reρ₁₂ and one-photon coherence Imρ₁₃, i.e., absorption change as a function of interaction time, which is determined by the pulse width of the control laser ω_{β} the input laser ω_{α} is cw. Optical parameters are the same as mentioned above. As seen in FIG. 7, the two-photon coherence excitation Reρ₁₂ is as fast as the applied Rabi frequency; here, generalized Rabi frequency Ω (square root of the sum of Ω_{α}² and Ω_{β}²) is 8.5 THz. Therefore, the coherence excitation definitely depends on the Rabi frequency of the applied lasers.

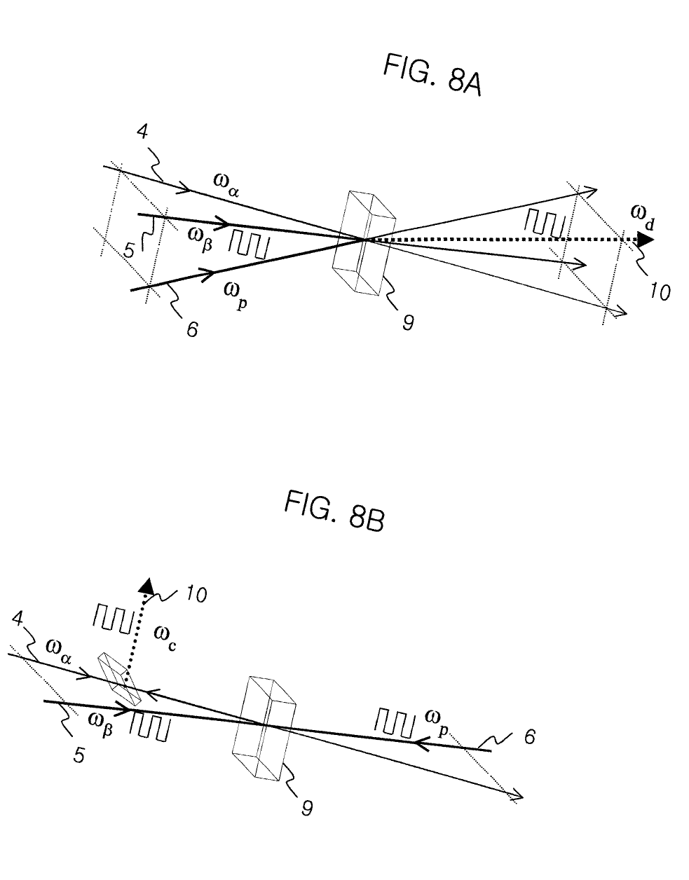

FIGS. 8A and 8B illustrate a specific apparatus of a quantum modulator for forward and backward propagation scheme, respectively. In FIG. 8, the three-laser inputs 4 through 6 are focused by a lens (not shown in FIGS. 8A and 8B) and do not co-propagate. The directions of the diffracted signal 10 of FIG. 8A should satisfy Bragg conditions made up with three-input lasers 4 through 6. The direction of the phase conjugates 10 of FIG. 8B should satisfy the phase matching conditions. In any case, either FIG. 8A or 8B, the diffracted signal of phase conjugate is back scattering free. For the nondegenerate four-wave mixing propagating in pulsed scheme, time delay may be needed for the probe laser ωₚ depending on δₚ as discussed in FIG. 2. This time delay τ is to avoid unnecessary interactions with degenerate four-wave mixing produced by the laser lights ω₃ and ωₚ. The amount of time delay τ should be shorter than phase decay time T2 of the transitions between two ground states |1> and |2>.

While the present invention has been described with respect to certain preferred embodiments, it will be apparent to those skilled in the art that various changes and modifications may be made without departing from the scope of the present invention as defined in the following claims.

What is claimed is:

1. A method of for quantum modulating optical signals by using a nonlinear optical medium, wherein the nonlinear optical medium includes two closely spaced ground states |1> and |2> such that the transition among the ground states is dipole forbidden, and an excited state |3> such that two-photon transition between the ground states |1> and |2> via the excited state |3> is allowed, the method comprising the steps of:
a) applying a first continuous wave (cw) laser light as an input to the nonlinear optical medium through an optical fiber or free space at a frequency of ω_{α} corresponding to a first transition between the ground state |1> and the excited state |3>;
b) applying a second laser light to the nonlinear optical medium through an optical fiber or free space at a frequency of ω_{β} corresponding to a second transition between the ground state |2> and the excited state |3>;
c) adjusting the intensities of the first laser light ω_{α} and the second laser beam ω_{β} to produce a strongly driven superposition state composed of the ground state |1> and the |2> creating two-photon coherence induction Reρ₁₂;
d) applying a third laser light to the nonlinear optical medium through an optical fiber or free space at a frequency of ωₚ corresponding to a third transition between the ground state |2> and the excited state |3> for nondegenerate four-wave mixing or phase conjugation geometry with the first laser light ω_{α}, the second laser light ω_{β}, and the third laser light ωₚ to produce nondegenerate four-wave mixing signal ω_{d}; and
e) connecting the nondegenerate four-wave mixing signals ω_{d} to an optical fiber.

2. The method of claim 1, wherein the excited state |3> is selected such that its energy level is higher than the energy level of the ground state |1> and the |2>.

3. The method of claim 1, wherein the ground state |2> is selected such that its energy level is higher than the energy level of the ground state |1>.

4. The method of claim 1, wherein the second laser light ω_{β} and the third laser light ωₚ are synchronized to satisfy a temporal and spatial overlap of the laser lights ω_{α}, ω_{β} and ωₚ in the nonlinear optical medium, and frequency difference δₚ between the second laser light ω_{β} and the third laser light ωₚ is near the Rabi frequency Ωₚ of the ωₚ.

5. The method of claim 1, wherein the second laser light ω_{β} and the third laser light ωₚ are synchronized to satisfy a temporal and spatial overlap of the laser light ω_{α} with the ω_{β} and the ωₚ, but keeping temporal delay of the laser lights ωₚ from the ω_{β} by l no longer than phase decay time T2 among the two ground states |1> and |2> with negligible frequency difference δₚ between the second laser light ω_{β} and the third laser light ωₚ.

6. A method for quantum modulating optical signals by using a nonlinear optical medium, wherein the nonlinear medium includes two closely spaced ground states |1> and |2> such that the transition between the ground states is dipole forbidden, and two closely spaced excited states |3> and |4> such that the transition between the excited states is dipole forbidden, and such that two-photon transition between the ground state |1> and the |2> via the excited stage |3> or |4> is allowed, the method comprising the steps of:
f) applying a first continuous wave (cw) laser light as an input to the nonlinear optical medium through an optical fiber or free space at a frequency of ω_{α} corresponding to a first transition between the ground state |1> and the excited state |3>;
g) applying a second laser light to the nonlinear optical medium through an optical fiber or free space at a frequency of ω_{β} corresponding to a second transition between the ground state |2> and the excited state |3>;
h) adjusting the intensities of the first laser light ω_{α} and the second laser beam ω_{β} to produce a strongly driven superposition state composed of the ground state |1> and the |2> creating two-photon coherence induction Reρ₁₂;
i) applying a third laser light to the nonlinear optical medium through an optical fiber or free space at a frequency of ωₚ corresponding to a third transition between the ground state |2> and the excited state |4> for nondegenerate four-wave mixing or phase conjugation geometry with the first laser light ω_{α}, the second laser light ω_{β}, and the third laser light ωₚ to produce nondegenerate four-wave mixing signal ω_{d}; and
j) connecting the nondegenerate four-wave mixing signals ω_{d} to an optical fiber.

7. The method of claim 6, wherein the excited states |3> and |4> are selected such that their energy levels are higher than the energy level of the ground state |1> and the |2>.

8. The method of claim 6, wherein the ground state |2> is selected such that its energy level is higher than the energy level of the ground state |1>.

9. The method of claim 6, wherein the second laser light op and the third laser light ωₚ are synchronized to satisfy a temporal and spatial overlap of the laser lights ω_{β}, ω_{β} and ωₚ in the nonlinear optical medium, and frequency difference δₚ between the second laser light ω_{β} and the third laser light Ωₚ is the same as the frequency difference between the excited states |3> and |4>.

10. The method of claim 6, wherein the second laser light ω_{β} and the third laser light ωₚ are synchronized to satisfy a temporal and spatial overlap of the laser light ω_{α} with the ω_{β} and the ωₚ, but keeping temporal delay of the laser lights ωₚ from the ω_{β} by l no longer than phase decay time T2 among the two ground states |1> and |2> with negligible frequency difference δₚ between the second laser light ω_{β} and the third laser light ωₚ.

11. An apparatus for quantum modulating optical signals by using a nonlinear optical medium, wherein the nonlinear medium includes two ground states |1> and |2> such that the transition between the ground states |1> and |2> is dipole forbidden, and an excited states |3> such that two-photon transition between the ground states |1> and |2> via the excited state |3> is allowed, the apparatus comprising:
a) a first laser light source for applying to the nonlinear optical medium at a frequency of ω₁ corresponding to a first transition between the ground state |1> and the excited state |3>;
b) a second laser light source for applying to the nonlinear optical medium at a frequency of ω₂ corresponding to a second transition between the ground state |2> and the excited state |3>;
c) a means of splitting a third laser light from the second laser light for applying to the nonlinear optical medium at a frequency of ωₚ corresponding to a third transition between the ground state |2> and the excited state |3>; and
d) a means for adjusting the intensities and the frequencies of the first light, the second light, and the third light to produce a coherent superposition state of the ground state |1> and the |2>.

12. The apparatus of claim 11, wherein the nonlinear optical medium is a solid.

13. The apparatus of claim 11, wherein the nonlinear optical medium is a doubly coupled semiconductor quantum wells.

14. The apparatus of claim 13, wherein the two ground states |1> and |2>, and the excited state |3> are selected in conduction band of the doubly coupled semiconductor quantum wells.

15. The apparatus of claim 11, wherein the first laser light source delivers single-mode light.

16. An apparatus for quantum modulating optical signals by using a nonlinear optical medium, wherein the nonlinear optical medium includes two ground states |1> and |2> such that the transition between the ground states |1> and |2> is dipole forbidden, and two excited state |3> and |4> such that the transition between the excited states |3> and |4> is dipole forbidden, and such that two-photon transition between the ground states |1> and |2> via the excited state |3> or the excited state |4> is allowed, the apparatus comprising:
a) a first laser light source for applying to the nonlinear optical medium at a frequency of ω₁ corresponding to a first transition between the ground state |1> and the excited state |3>;
b) a second laser light source for applying to the nonlinear optical medium at a frequency of ω₂ corresponding to a second transition between the ground state |2> and the excited state |3>;
c) a means of splitting a third laser light from the second laser light for applying to the nonlinear optical medium at a frequency of ωₚ corresponding to a third transition between the ground state |2> and the excited state |4>; and
d) a means for adjusting the intensities and the frequencies of the first light, the second light, and the third light to produce a coherent superposition state of the ground state |1> and the |2>.

17. The apparatus of claim 16, wherein the nonlinear optical medium is a solid.

18. The apparatus of claim 16, wherein the nonlinear optical medium is a doubly coupled semiconductor quantum wells.

19. The apparatus of claim 18, wherein the two ground states |1> and |2>, and the two excited states |3> and |4> are selected in conduction band of the doubly coupled semiconductor quantum wells.

20. The apparatus of claim 16, wherein the first laser light source delivers single-mode light.
